(19) United States
(12) Patent Application Publication
(10) Pub. No.: US 2004/0000527 A1
(43) Pub. Date: Jan. 1, 2004

(54) Apparatus and method for storing sheets

(76) Inventor: Pavel Repisky, Warminster, PA (US)

Correspondence Address: JOHN R. EWBANK, 1150 WOODS ROAD, SOUTHAMPTON, PA, 18966-4545, US

(21) Appl. No.: 10/185,207

(22) Filed: Jun. 27, 2002

(51) Int. Cl. B42F 1/00

(52) U.S. Cl. 211/50

(57) ABSTRACT

Stability is imparted to vertically stored sheets by positioning guiding members imparting to such sheets an observable curve involving an arc height which is about 1% to about 100% of its radius of curvature.

### BACKGROUND

This invention relates to storage systems permitting storage of sheets efficiently as regards the time required for inserting into and removal from storage, compactness of storage, ease of removing approximately one sheet at a time when desired, permitting freshly printed sheets to dry in the presence of a natural air current, and attaining other advantages over what has been conventional practice. Some aspects are particularly advantageous in the retail marketing of sheets of paper for use by artists.

Heretofore many stores selling art supplies have provided deep shelves on which various types and colors of art paper could be stored horizontally, thereby making it plausible to remove the top sheet when desired. Dust sometimes settles on the top sheet when sheets are stored in the standard horizontal storage system. An art store needs to have prompt access to some of the varieties of sheets needed for an attractive inventory. As Halloween approaches, the popularity of orange and black colors leads to additional problems. Although the hardware systems for marketing art paper has been significantly different from the filing of office documents, a few generalists recognized some analogies between storage of art papers and the filing cabinets for office documents such as bills, letters, and memos.

Heretofore there have been many varieties of office filing cabinets in which sheets were filed vertically, and in which there were potentialities for withdrawing one sheet at a time. Some office filing hardware has employed the convenience of lateral removal, but other systems have used access from the top to the stored sheets. Suspension folders have permitted a plurality of sheets to rest upon the bottom of the suspension loop. Portable storage facilities on wheels have been used in offices, but rarely applied to retail stores for the marketing of paper for use by artists.

Storage problems for sheets are influenced by the relative stiffness of the sheet. In a lumberyard storing large panels of one-inch plywood, forklift trucks can sometimes extract a sheet from the top of a horizontal stack of sheets. In stores selling craft supplies, including sheets of plywood or other panels [ordinarily much smaller than the 4 by 8 foot standard plywood panel] having thicknesses such as one-eighth inch, storage for easy access manually to one sheet involves unique problems. Horizontal storage necessitates a plurality of bins so that the customer can inspect a plurality of thicknesses, colored facings, and other variations. Heretofore conventional vertical storage has involved risks of scratching of a face by reason of the sheets tending to undergo random shifting of positions during storage.

Some sheets, such as knitted fabrics, have such excessive sagginess as to be unsuitable for vertical storage except in combination with an appropriate stiffening package member. Most art papers have sufficient stiffness to be suitable for positioning vertically, but tend to sag troublesomely when stored vertically for weeks. Art supplies have been marketed for centuries without satisfactorily coping with some of the hardware storage problems. There has been a long-standing demand for some system for storing sheets vertically in such a manner as to expedite the easy removal of one or more sheets at a time.

### SUMMARY OF INVENTION

In accordance with the present invention, sheets are stored vertically in such a manner that instead of the normal straight line between the lateral edges of the sheet, at least one observable curvature is imparted to the sheets because of the impact of one or more guiding members, thereby stabilizing the sheets so that they can rest upon the floor of the storage facility. In some embodiments, the guiding members impart a lateral squeezing action so that the storage distance between the two vertical edges of the storage facility is less than the width of the sheet, thereby squeezing the sheet into a slight but observable curve.

For thin panels having a thickness of from about 1/16 to ¼ inch, the curve can be imparted by a pair of lateral guiding members so that each panel is positioned by a pair of lateral grooves. The distance between lateral grooves is slightly less than the width of the thin panel, but only slightly less, so that a clerk can readily slide a thin panel into or out of its intended pair of grooves. Because the inter-groove distance is slightly less than the width of the thin panel, a slight but observable curve is thus imparted to such thin panel, such as plywood. The thus curved stiff sheet can rest upon the floor of the storage device without any propensity to lean in either direction, thus decreasing the potentialities for any scratching of the faces of the thin panel. Such vertical storage of stiff sheets makes feasible the rapid evaluation by customers of a plurality of different colors of panel.

The same principles concerning the stabilization of a vertical sheet are applicable, not merely to thin panels, but also to many varieties of sheets capable of resting on the floor of the storage facility when thus guided by the guiding members into an observable curve. Thus the sheet, instead of being a straight line between its vertical lateral edges, forms an arc which is at least observable.

In another embodiment of the invention, suitable for sheets which have both the flexibility for a greater curve and the poor memory permitting easy flattening, the curve can be relatively large such as a semi-circle. Such range of size of the curve can be described by discussing the “arc height” from the curve to the chord across such curve. If the curve is a semicircle, then the arc height is 100% of the radius of curvature. If for a 48-inch panel, the arc height is 0.24 inch, then the arc height is 1% of the radius of curvature. A range of curvature of “at least observable curvature” is believed to be approximately equivalent to a range of arc height from 1% to 100% of the radius of curvature.

When the sheet is withdrawn, it is readily flattened because the curvature that is imparted to the stored sheet is within the range that, for that kind of sheet, permits the poor memory of the material to expedite flattening. The curvature is employed primarily for greater convenience during storage so that the sheet can rest upon the floor with stability.

The method of the present invention involves the use of guiding members to impart such stabilizing curve to a sheet so that it can stand vertically on the floor without sagging, leaning, or other adverse movement. That is, the curve imparts an advantageous stabilization to the vertical storage of bendable sheets. By using sheets slightly wider than the lateral distance between the sidewalls of a multi-slotted vertical bin, a few sheets could be induced to maintain such desired curve, thus achieving stability. Prior art multi-slotted vertical bins customarily have had rectangular slots because the partitions between the slots have been straight-line partitions. In accordance with selected embodiments of the present invention, the apparatus features curved partitions between the slots of a novel multi-slotted vertical bin. In some embodiments of the invention, such curving of the partitions can be about equal or slightly more curved than are the sheets by reason of the squeezing by the sidewall serving as guiding members. In a multi-slotted bin having rectangular slots, a sheet might position itself diagonally so that a sheet had a straight line between its vertical edges, thus taking such installation outside the scope of the present invention. The curved partition arrangement permits a greater range of number of sheets to be fitted within the slot without significant risk that a sheet might position itself diagonally within the slot in a straight-line manner.

In another embodiment of the invention, narrow slotted bins are formed between curved partitions that are semi-circular or at least more than slightly curved. In such an embodiment, there is trivial likelihood of diagonal positioning permitting straight-line alignment between the two vertical edges of the sheet. In such embodiment, the curved partitions function as the guiding members imparting the curve to the stored sheets that can be of various widths, because the sidewalls do not need to exert any squeezing action.

As previously noted, packaging is sometimes appropriate for sheets of knitted fabric or other extremely saggable sheets so that a sheet that is laterally squeezed by the guiding members (lateral walls positioned apart a distance sufficiently less than the sheet width) to impart the desired arc to the sheet squeezed by such guiding members. Most art papers are sufficiently stiff to be suitable for storage in the bins thus created by the plurality of curved partitions between the vertical bins. Multiple bins having curved partitions can be made in various ways, but are significantly distinguishable from multiple bins having straight-line partitions. The combination of the lateral walls as the guiding members slightly squeezing the paper into an arc and the curved partitions is adaptable not merely to retail display systems, but also to disposable shipping container to a store prepared to market an appropriate inventory of art papers, such shipping container being adapted to fit into one of the varieties of marketing apparatus, such combination embodying the method of the present invention.

Several modifications comply with the requirement for vertical bins having guiding members imparting a curve to the stored sheet so that there is not the straight line between the vertical edges of the stored sheet. The guiding members can impart a plurality of curves instead of a single curve. Although it is usually desirable for a single curve to be throughout the width of the sheet, such curve might be for only a portion of such width.

The method of the present invention consists of stabilizing vertically aligned sheets by imparting an observable curve to such sheets instead of maintaining the normal straight-line relationship between the vertical edges of the sheets. The height of the arc of such curve should desirably be within 1% to 100% of the radius of curvature.

### DESCRIPTION OF DRAWINGS

FIG. 1 is a perspective, partially broken view of a multiple-slotted vertical bin having the spacing between sidewalls adapted to guide or squeeze stored sheets of predetermined width greater than the straight-line distance between such lateral sidewalls, there being a plurality of curved partitions between such relatively narrow slots

FIG. 2 is a schematic cross section of an arrangement permitting panels to be slid in and out of a pair of grooves that are laterally spaced close enough together to impart a slight but observable curve to the panel. On each lateral wall, the grooves are spaced far enough apart that panels do not scratch each other but close enough together for plausibly efficient storage capacity per unit volume.

FIG. 3 is a schematic view of an installation permitting a vertically aligned sheet to have a plurality of curves by reason of a plurality of guiding members extending upwardly from the storage floor. Such plurality of vertically positioned guiding members does not require any squeezing by the sidewalls, and permit storage of sheets of varying width. In inserting a sheet downwardly into its storage space, the multiple curves are imparted to the sheet (generally manually) prior to being positioned on the floor of the storage facility. However, a clerk can readily remove a sheet from a storage facility featuring the plurality of guiding members extending upwardly from the floor.

FIG. 4 is a schematic view (simulating a cross section) of guiding members adapted to narrow the effective space between the lateral walls of a rectangular slot in a multi-slotted vertical bin. Supplemental guiding members, (both concave and convex) that can be positioned on a straight-line partition of a multiple-bin storage device of the prior art. Insertable guiding members permit sheets to be stored in accordance with the method of the present invention even in a slotted vertical bin of the prior art design.

FIG. 5 is a schematic perspective view of a system permitting the drying of freshly modified sheets such as freshly printed sheets.

FIG. 6 is a schematic perspective view of a portable device useful for marketing art paper and similar sheets, including the potentiality of cooperating with a shipping container insert resembling FIG. 1.

FIG. 7 is a schematic view of a shipping container permitting the shipment of a plurality of packages of wide paper in a carton having lateral dimensions somewhat shorter than the sheets of paper, thus accommodating to limitations affecting the dimensions of shipping containers.

### DETAILED DESCRIPTION

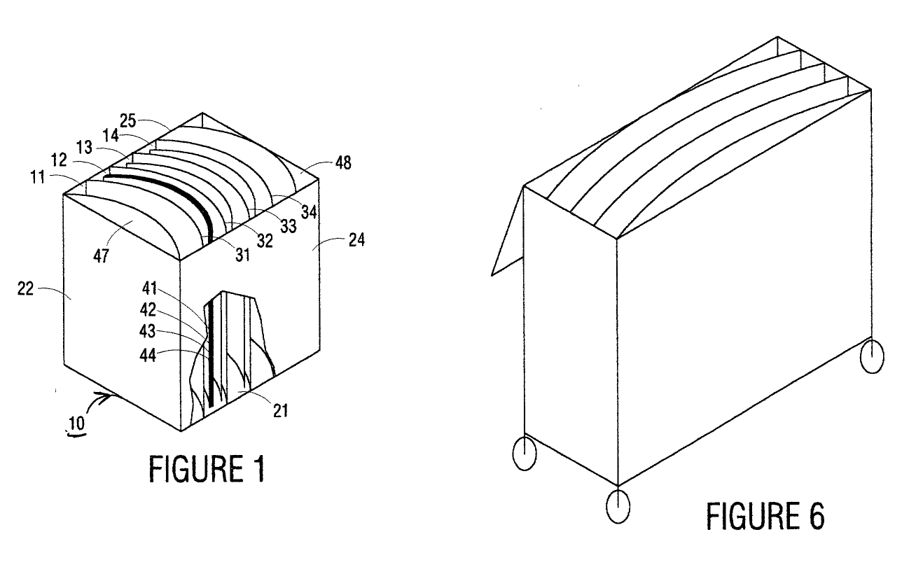

As shown in FIG. 1, a facility 10 for the vertical storage of thin sheets comprises a plurality of vertical bins, including those designated as 11, 12, 13, and 14. Said facility comprises a floor 21, end-walls, only one 22 being shown, and sidewalls 24, 25. Particular attention is directed to the fact that the lateral spacing between sidewalls 24, 25 is slightly less than the width of the sheets for which the storage facility is to be used. Hence the sidewalls 24 and 25 function as guiding members effectively squeezing a sheet so that it forms an arc that is both observable and has an arc height that is within 1% and 100% of the radius of curvature. Thus the sheet is stabilized so that it can rest on the floor without sagging, as it would if there were the combination of straight line positioning of a sheet of paper between sidewalls spaced apart the full width of the paper. Between a pair of partitions is a slot. In slots shaped like a rectangle, and relying merely upon the sidewalls as guiding members squeezing a sheet to form an arc, a sheet might be misaligned diagonally to be outside the present invention. Accordingly, if the slots are rectangular, they should also be relatively narrow in their linear dimension. With rectangular slots, the effectiveness of the sidewalls a guiding members is restricted to such narrow slots.

In the apparatus shown schematically in Fig. L, the partitions 31, 32, 33, 34, between the bins 11, 12, 13, 14, are not straight line perpendicular to the side-walls 24, 25, as is conventional in bin construction, but are curved and function as supplemental guiding members for imparting a curve to sheets 41, 42, 43, 44, in a bin. At each end appropriate guiding members, 47, 48, shape the bins at the ends to conform to the curved slot type of bin shown for the central portion of the narrow slotted vertical bin. Because sheets 41, 42, 43, 44, are guided into an observable curve, they are stabilized, and can stand on the floor 21 without sagging. From the top, one of the sheets 41, 42, 43, 44, can be removed and used without excessive problems in flattening it. The apparatus of the general nature shown schematically in FIG. 1 has a variety of applications. For example, a shipping container can feature a box-like cover over a curved slotted vertical bin (generally like FIG. 1) containing a plurality of colors and weights of art paper. Upon arrival at the store, the box-like cover can be removed, and the curved slot bin containing the paper placed in a display unit ready for marketing. Thus the art paper can go from the wholesaler to the retailer without any separate wrapping of the various types of art paper.

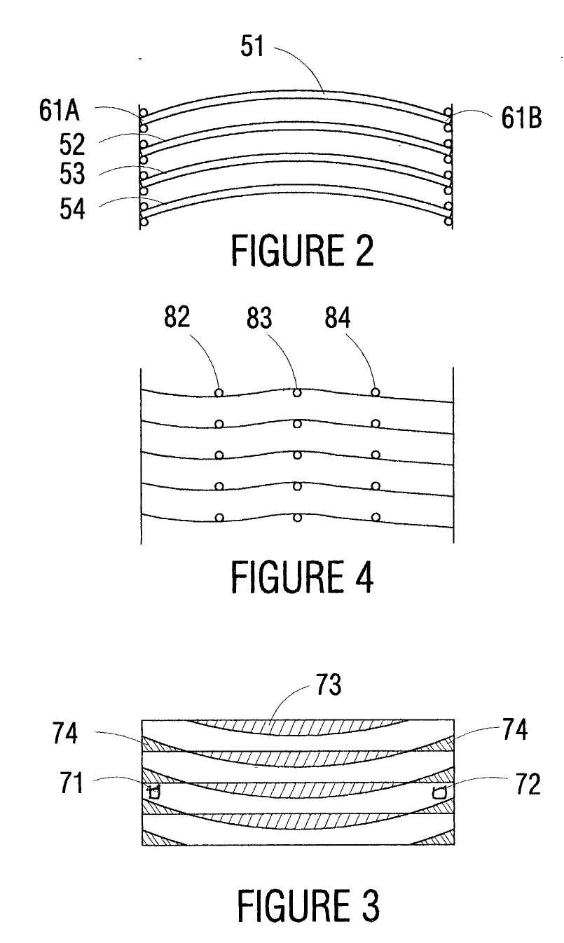

As shown in FIG. 2, the invention can be applied not merely to art papers, but also to panels having a stiffness greater than art paper. FIG. 2 is a schematic view of a system in which each of a series of thin but slightly stiff panels 51, 52, 53, 54 is slightly bent in order to place it in a pair of grooves 61a, 61b positioned vertically on the sidewalls of the storage facility. These grooves 61a, 61b, are closer together than the width of the thin panel. At least one face of the panel is generally decorated in such a manner that it should not be scratched, as it can be when stored vertically in a conventional rectangular bin, or when piled horizontally. Because the panel is thin, and because the height of the arc is small, the clerk can readily slide a panel in and out of its pair of grooves 61a, 61b so that during storage the panel 51 is resting on the floor of the storage facility. Each of a plurality of thin panels can rest on the floor without propensities to lean against other panels by reason of the slight but observable curve imparted to the panels by the proper spacing of grooves 61a, 61b, functioning as guiding members. Instead of there being the normal straight line between the vertical edges of the panel, there is a slight but observable curve. A sales clerk can readily slide the slightly curved sheet from the top down until the sheet is standing on the floor of the storage facility. Whether days or months later, a clerk can also readily slide the sheet vertically from its storage position. Thus a plurality of differently colored, patterned, etc. stiff sheets can be vertically stored with quick and easy access to each.

If there were rectangular bins having a lateral dimension slightly greater than that of the sheets, and having a sufficiently short dimension between partitions to be treated as a slotted bin, then insertion, removal, and random movements of the sheets could scratch the faces of some of the sheets. The present invention stabilizes the position of each sheet, while still making it readily removable with less likelihood of scratching a decorated face of the sheet.

As shown in FIG. 3, a storage facility having a plurality of narrow slotted rectangular bins can be transformed for the practice of the method of the present invention by the use of guiding members designed for retro-fitting onto such rectangular-binned storage facility. A floor, sidewalls, endwalls, and straight-line partitions forming a plurality of slotted vertical bins can be modified by appropriate guiding members. If the slots are so narrow that only a few sheets can be accommodated, then the method of the present invention might be practiced by using one or more lateral guiding members 71, 72 to narrow the bin width to observably shorter than the width of the sheets to be stored, thereby imparting to the stored sheets an arc or curve that is slight but observable. Such lateral guiding members 71, 72 can be sometimes (particularly when the slots are relatively broad instead of narrow) supplemented by a plurality of guiding members such as a central concave guiding member 73, and a pair of convex guiding members 74. Such supplemental guiding members can decrease any propensity for a sheet to revert to straight-line alignment between the vertical edges of the sheet when misaligned diagonally within its slot. Thus traditional straight-line partition type of vertical bins can be updated to utilize the present invention by the installation of such guiding members.

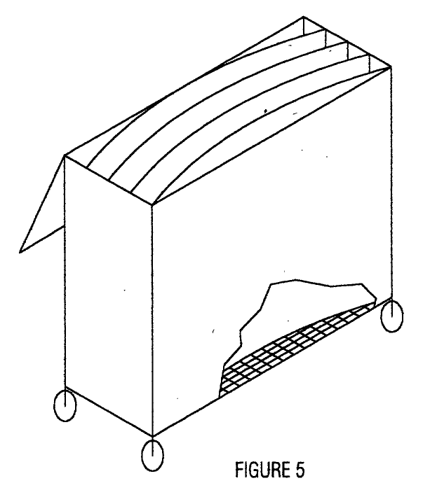

As shown in FIG. 4, there is a schematic cross sectional view clarifying how guiding members can extend upwardly from the floor to impart to a saggable sheet one or more slight but observable curves. Simple vertical rods can serve as such guiding members. In the schematic view of FIG. 4, three vertical rods 82,83, 84 are positioned at about 25%, 50%, and 75% of the width between the sidewalls. Each rod is deemed to have a forward and a rearward surface relative to what is deemed to be the forward and rearward slots. A sheet or a group of sheets can be positioned so that the paper contacts the face of the central rod that is opposite the faces of the other two rods, thus imparting at least one slight but observable curve to the width of the sheet. Inserting the paper so that it has a somewhat S-shaped curve requires plausible care. However, the removal of a sheet is quite simple. Such rods can also be retrofitted into conventional rectangular bins for updating to practice the present invention.

A storage facility can have a plurality of upright guiding members positioned to impart a plurality of curves to the width of the vertically stored sheets, each curve complying with the slight but observable requirements. The plurality of curves stabilizes the vertical position of the saggable sheet. With sheets having the flexibility of typical art paper, the plurality of curves permits attainment of acceptable stability with a smaller arc height than for a single curve.

Heretofore artists have had problems when printing art paper because such printed (or otherwise processed) sheets must dry before being stacked upon each other. Prior art practice has been to provide a large area in which various sheets could dry horizontally. Unfortunately, gentle air currents for accelerating such drying are generally not available. The method of stabilizing the vertically stored sheet permits upflowing air currents to dry such items more rapidly and within a smaller area. As shown in FIG. 5, the floor for the drying zone is modified to have air inlets, such as by using a wire mesh floor for the storage facility. Convection currents naturally flow upwardly through the vertically stabilized sheets for drying them rapidly. When using the method of the present invention significantly for such drying method, a fan can be employed for increasing such upflowing-drying stream of air.

As shown in FIG. 6, a storage facility can be portable, and have casters so that the wheels can be locked for stable positioning. Such a portable storage unit permits a clerk to sell sheets of craft paper from any of many locations, providing the equivalent of a sales counter top wherever desired. Stores other than craft shops can sometimes sell colored paper during seasons such as St. Patrick's Day, Halloween, and Christmas, particularly if the inventory can be appropriately positioned in the store. Because the portable unit is not merely for storage but also for retailing, an upper edge of a front face of such a portable storage facility can have a cutting edge, so that a sheet of art paper can be cut to size to meet the needs of a customer. Such a portable storage unit can have at least one transparent wall permitting both the clerk and the customer to observe the variety of thicknesses, colors, etc. of paper available from such storage unit. Such transparency and ease of inspection thus saves the time of both the clerk and the customer.

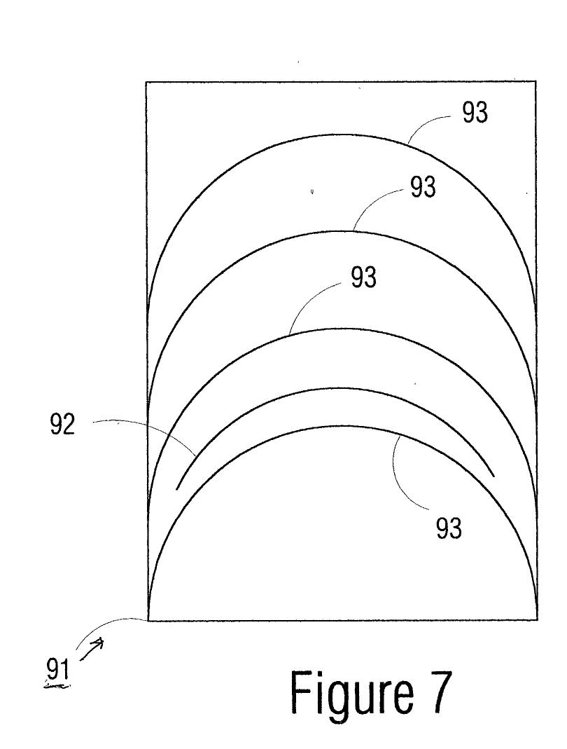

As shown in FIG. 7, the present invention can be applied to shipping containers for art paper for the purpose of meeting various limitations concerning the dimensions of shipping containers. Some artist's sheets are wide enough normally to require shipping through systems permitting long lateral dimensions. By using the present invention, however, such wide paper can be shipped in a curved condition so that the lateral dimension is narrow enough to comply with the rules for less costly shipping. Such wide paper can be curved into an approximate semicircle, thus narrowing its lateral dimension. A shipping container 91 can accommodate a plurality of sheets of wide artist paper 92 shaped into an approximately semicircle by a plurality of semicircular partitions 93. Because such a shipping container might be subject to adverse forces during shipment, suitable precautions need to be taken that might not be needed for a standard storage device.

The method of the invention consists of stabilizing vertically aligned sheets by imparting to such sheets an observable curve instead of maintaining the straight-line relationship between the vertical edges of the sheet. The propensity of a sheet to retain memory of its curving is significantly dependent upon the height of the arc relative to the effective radius of curvature. Such arc height should be within the range from 1% to 100% of curvature. When there is only a slight but still observable curvature, the stabilization is achieved without excessive problems in flattening the sheet subsequent to storage.

Various modifications of the invention are plausible without departing from the scope of the appended claims.

The invention claimed is:

1. [Independent] In a device suitable for the storage of a plurality of vertically aligned sheets of material said storage device having a floor, endwalls, side-walls, the improvement which consists of positioning at least one guiding member so that it imparts to each sheet an observable curve having the effect of stabilizing the vertical alignment of such sheets.

2. The device of claim 1 in which the sheets are flexible and saggable whereby the sheets are floor-supported without troublesome sagging.

3. The device of claim 2 in which at least one guiding member repositions at least one sheet to have a curve instead of conforming to a straight line between the two vertical edges of a sheet, the height of the arc of the curve being from 1% to 100% of the radius of curvature of such arc.

4. The device of claim 3 in which a plurality of members reposition at least one sheet to have a single curve instead of conforming to a straight line between the two vertical edges of a sheet.

5. The device of claim 3 in which a plurality of members reposition at least one sheet to have a plurality of curves instead of conforming to a straight line between the two vertical edges of a sheet.

6. The device of claim 1 in which the floor of the storage device has openings permitting the upward flow of air, whereby each separately stored sheet can be subjected to air-drying while being maintained in its stabilized vertical position.

7. The device of claim 1 in which at least one sheet is moderately stiff, in which such stiff sheet is supported by the floor with its vertical edges slideably confined between two lateral groove members imparting to such stiff sheet a slight curve so that each such stiff sheet remains upright without touching other sheets, while permitting the thus-curved stiff sheets to be slid vertically from its storage zone.

8. [Independent] A portable marketing device consisting essentially of: a plurality of lockable casters; a storage zone supported upon and moveable with such casters; a floor, sidewalls, endwalls, and a cover in said storage zone; a plurality of vertical slotted bins in said storage zone for the vertical storage of saggable sheets; curved partitions between the slots, such partitions serving as guiding members imparting an observable curve to the vertically aligned sheets instead of a straight line between the outside edges of a sheet, the height of the arc of such curve being from about 1% to about 100% of the radius of curvature of the arc, whereby the sheets can rest upon the floor of said storage zone without troublesome sagging, and whereby the withdrawn sheets can be satisfactorily flattened.

9. [Independent] The method of stabilizing the vertical storage of thin sheets which consists of employing guiding members to impart to such sheets an observable lateral curve between the lateral vertical edges of the sheets.

10. The method of claim 9 in which the curve imparted by the guiding members features an arc height that is from about 1% to about 100% of the radius of curvature.
